(19) United States
(12) Patent Application Publication
(10) Pub. No.: US 2017/0198168 A1
(43) Pub. Date: Jul. 13, 2017

(54) CONFORMABLE, REMOVABLE FILM-BASED ARTICLE

(71) Applicant: 3M INNOVATIVE PROPERTIES COMPANY, St. Paul, MN (US)

(72) Inventors: John P. Baetzold, North St. Paul, MN (US); Robert R. Condon, Woodbury, MN (US); Shawn C. Dodds, St. Paul, MN (US); Thomas B. Galush, Roseville, MN (US); Thomas Herdtle, Inver Grove Heights, MN (US); Mikhail L. Pekurovsky, Bloomington, MN (US); John J. Stradinger, Roseville, MN (US)

(21) Appl. No.: 15/313,561

(22) PCT Filed: Jun. 3, 2015
(86) PCT No.: PCT/US15/33887

§ 371 Date: Nov. 23, 2016

Related U.S. Application Data
(60) Provisional application No. 62/008,598, filed on Jun. 6, 2014.

(51) Int. Cl. C09J 7/02; B32B 38/00; B32B 38/10; B32B 37/10

(52) U.S. Cl. CPC C09J 7/0207; B32B 37/10; B32B 38/0004; B32B 38/10; C09J 2203/306; C09J 2433/003

(57) ABSTRACT

A conformable, removable film-based article having a patterned, discontinuous upper protective layer. The upper layer may be configured to facilitate enhanced removability of the film from a substrate, such as an automobile's exterior surface, to which it has been applied.

### BACKGROUND

Films are often bonded to substrates utilizing pressure-sensitive adhesives. The films are generally bonded to a variety of different substrates including, for example, surfaces on motor vehicles. Removal of such films is traditionally accomplished by manually pulling on an edge of such film, which may cause the film to fracture.

### SUMMARY

Films with a patterned protective coating that facilitates ease of removal while preserving protective and visual aspects of the protective coating. The patterned protective coating in one embodiment comprises island-like features that may or may not be visible to an observer, in a density that effects surface protection. At the time of removal, these patterned films in some embodiments may be much less prone to breakage, thus facilitating ease of removability.

In one embodiment, a conformable, removable film-based article is described, the article comprising a conformable film having a first major surface and a second major surface; a pressure sensitive adhesive layer on the first major surface of the conformable film; and a discontinuous, patterned protective layer on at least a portion of the second major surface of the conformable film, wherein the patterned protective layer comprises a pattern that has an average areal coverage that is between 10% and 85% of the surface area of the portion of the conformable film.

In another embodiment, the patterned protective layer comprises features, and wherein such features are applied via a multiple printing step process, such that a protective material, such as hard coat, is printed on the conformable film in the discontinuous pattern, then a further printing step disposes an additional discontinuous pattern atop the already printed pattern.

This and other embodiments are described herein.

### BRIEF DESCRIPTION OF DRAWINGS

FIG. 1 is a drawing of a hard coated film.

FIG. 2 is a side view drawing of a conformable film-based article.

FIG. 3 is a drawing of a conformable, removable film-based article.

FIG. 4 is a drawing of a conformable, removable film-based article.

FIG. 5a is a plan-view drawing showing features that comprise the patterned protective layers.

FIG. 5b is a plan-view drawing showing features that comprise the patterned protective layers.

FIG. 5c is a plan-view drawing showing features that comprise the patterned protective layers.

FIG. 6 is a flowchart showing steps associated with making a conformable, removable film-based article.

### DETAILED DESCRIPTION

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

The recitation of numerical ranges by endpoints includes all numbers subsumed within that range (e.g. 1 to 5 includes 1, 1.5, 2, 2.75, 3, 3.80, 4, and 5) and any range within that range.

As used in this specification and the appended claims, the singular forms “a”, “an”, and “the” encompass embodiments having plural referents, unless the content clearly dictates otherwise. For example, reference to “a layer” encompasses embodiments having one, two or more layers. As used in this specification and the appended claims, the term “or” is generally employed in its sense including “and/or” unless the content clearly dictates otherwise.

The term “polymer” will be understood to include polymers, copolymers (e.g., polymers formed using two or more different monomers), oligomers and combinations thereof, as well as polymers, oligomers, or copolymers that can be formed in a miscible blend. In a blend of polymers, the term “polymer” will refer to the continuous phase polymer in the blend.

Unless otherwise indicated, “optically transparent” refers to an article, film or adhesive composition that has a high light transmittance over at least a portion of the visible light spectrum (about 400 to about 700 nm).

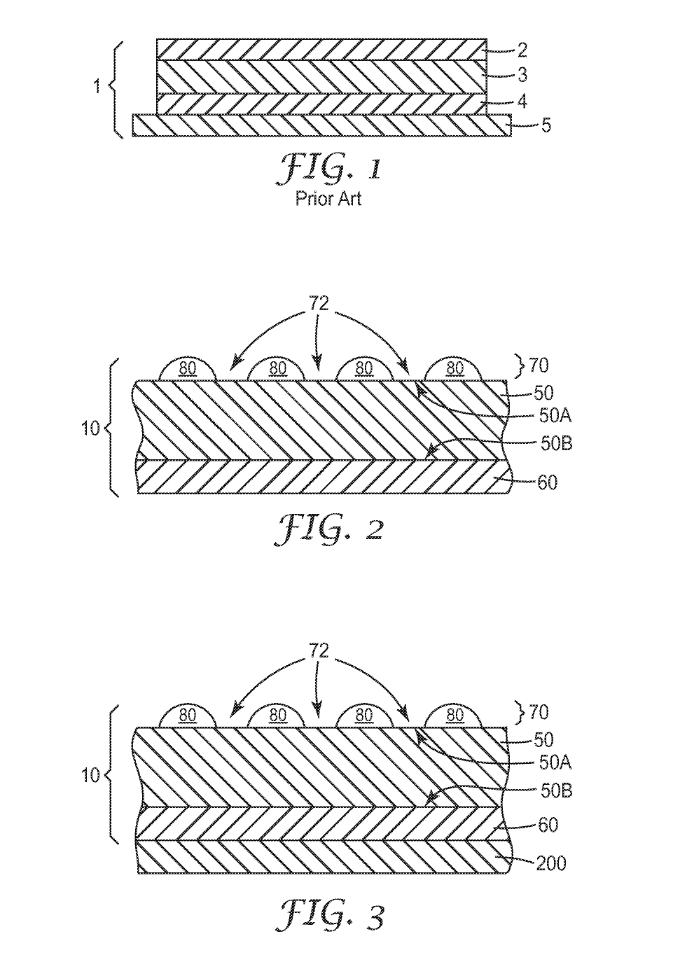

It is common for conformal film-based articles having a protective hardcoat layer to be difficult to remove from the surface to which the film-based article was applied. The conformal film with hardcoat fractures into relatively small sections upon an operator pulling the film upward (sometimes in the presence of heat). This tendency to break makes the hard coated film difficult to remove in large sections, which increases labor costs. In certain instances, the variability in stresses associated with such breakage could potentially contaminate or compromise an underlying finish, potentially leading to increased susceptibility to scratching. Such a hard coated film is shown in FIG. 1. Hardcoated film 1 includes a film layer 3, an adhesive layer 4, and a continuous, unpatterned hardcoat layer 2. Adhesive layer 4 bonds the hardcoated film 1 to an application surface 5.

Ease of removal may be desirable particularly in applications where removability is an expected part of the film product life cycle. For example, some vehicle wraps, that is, films applied to the exterior of a vehicle as a decorative wrap are usually not considered permanent, and may be eventually removed. Conventional hard coated films, as seen in FIG. 1, tend to break into relatively small pieces when an operator attempts to peel them off of a surface.

It has been discovered that film constructions having certain protective coating patterns may provide some benefits of the protective coatings, but also allow for much easier removal. For example, in some embodiments, films having such newly discovered protective coating patterns may be removed in a single piece, often without breaking, by an operator manually pulling the film away from the surface to which it is adhered. Of course, the ultimate ease with which a particular film adhered to a surface may be removed from that surface is a function of many things: the kind of substrate upon which a film is adhered; the adhesive(s) used; and film involved, etc. But in general, patterning a protective layer on a film as is described further herein has been found to improve the removability of that film as compared with a continuously, uniformly coated hard coated film, by decreasing its tendency to break. Such newly discovered film constructions have a pattern of features, usually on the top surface of the film-based articles, which provides surface protection and gloss control, and without causing issues with removability of the construction. The newly discovered film can be used, for example, in vehicle wraps as a protective overlaminate because it provides the proper finish while also offering protection and not substantially affecting application-related properties. Such application-related properties include the ability to be heated and stretched (sometimes up to or even exceeding 50% of starting area) around various shapes on the vehicle. Another application-related property is the ability for the film to be applied, removed, and then re-applied several times during application—usually in the presence of varying degrees of heat. Another application-related property is the film's level of gloss—ideally the original level of film gloss is preserved through the application process. Another application-related property is the film's ability to resist marring or streaking caused from an application tool deforming the edge of the film.

FIG. 2 shows a side-view drawing of a conformable film-based article 10. Conformable film layer 50 is shown sandwiched between an adhesive layer 60 and a discontinuous patterned protective layer 70. Discontinuous patterned protective layer is an array of hardcoat features on a film. The discontinuous patterned protective layer comprises areas of hardcoat on film adjacent to, or in some embodiments, separated by, regions with no or very little (in one embodiment less than 0.5 microns) of hardcoat. Conformable film layer 50, which may be comprised of one or more layers of films of various constructions, includes two major surfaces 50A and 50B. Major surface 50B interfaces with adhesive layer 60, whereas major surface 50A has upon it the discontinuous patterned protective layer. Conformable film-based article 10 may be constructed and delivered on a release liner (not shown in FIG. 2), which may include ridges that endow the adhesive layer 60 with a relief structure suitable for air and fluid egress upon installation. Generally, such a release liner is removed at the time of application, then adhesive layer 60 brought into contact with an application surface, such as an automobile surface or a wall, etc.

Conformable film layer 50 may be of any suitable construction. The conformable film utilized in the present inventive article is generally made of various plastic materials used conventionally by those skilled in the art. Suitable films include, for example, vinyl, polyvinyl chloride (PVC), plasticized polyvinyl chloride, polyurethane, polyethylene, polypropylene, fluororesin or the like. Other polymer blends are also potentially suitable, including for example thermoplastic polyurethane and a cellulose ester. In some embodiments, the cellulose ester is a cellulose acetate butyrate. In some embodiments, the cellulose ester is a cellulose acetate propionate. The thickness film can vary widely according to a desired application, but is usually within a range from about 300 microns or less, and preferably about 25 microns to about 100 microns.

PVC films, in particular, are conventionally used for a wide variety of applications, including graphic films. PVC has many properties that are advantageous for such applications, such as cost and durability. They are also easily printed using current printing technologies, e.g., piezo ink jet. PVC graphic films are usually conformable to the varying topographies present on the exterior of a substrate, for example a vehicle. Another suitable film type includes polyolefin films, or thermoplastic polyurethane and cellulose ester films as described in US Patent Application Publication No. 2014/0141214 or the films described in U.S. Patent Application No. 61/761,004.

A specific example of a suitable conformable film layer is a plasticized polyvinyl chloride film, which has sufficient inelastic deformation after being stretched so that when stretched, the film does not recover to its original length. Preferably, the film has an inelastic deformation of at least 5% after being stretched once to 115% of their original length. A typical formulation of the vinyl film includes polyvinyl chloride resin, light and/or heat stabilizer(s), plasticizer, and optionally, pigment. The amount of plasticizer is generally less than about 40% by weight, and is preferably composed of polymeric non-migratable plasticizers which are compatible with the vinyl film and provide the necessary flexibility and durability. A suitable plasticizer is a combination of polymeric polyester elastomer and an ethylene vinyl acetate copolymer (such as Elvaloy 742 made by DuPont Co.) soluble in aromatic solvents and present in amounts of about 26 parts and 10 parts, respectively, per 100 parts vinyl resin.

As mentioned, conformable film layer 50 may include other layers. For example, such other layers may include various colors and patterns of other films, various over laminate films that may be clear or light transmissive, ink layers, etc. These additional layers may be of the same or different chemistries and constructions.

By “conformable” it is meant that the film layer is one that is soft and flexible so as to accommodate curves, depressions, or projections on a substrate surface so that the film may be stretched around curves or projections, or may be pressed down into depressions without breaking or delaminating the film. It is also desirable that the film does not delaminate or release from the substrate surface after application (known as popping-up). Graphic films may also be imageable (i.e. able to receive printing and/or graphics) and exhibit good weathering for outdoor applications.

Adhesive layer 60 may be any suitable adhesive. Suitable adhesives can be selected from a variety of conventional adhesive formulations. Non-limiting examples of adhesives include pressure sensitive adhesives, heat activated adhesives, radiation curable adhesives, and the like. Examples of formulation types include solvent-based solutions, water-based, latex, microspheres, hot melt coatable, and suitable combinations thereof.

Adhesive layer 60 may comprise further layers, such as primer layers to enhance the bond between the adhesive layer and the film layer. The type of primer will vary with the type of film and adhesive used and one skilled in the art can select an appropriate primer. Examples of suitable primers include chlorinated polyolefins, polyamides, and modified polymers disclosed in U.S. Pat. Nos. 5,677,376, 5,623,010 and those disclosed in WO 98/15601 and WO 99/03907, and other modified acrylic polymers. Typically, primers are dispersed into an adequate solvent in very low concentrations, e.g., less that about 5% solids, and coated onto the film, and dried at room or elevated temperatures to form a very thin layer. Typical solvents used may include water, heptane, toluene, acetone, ethyl acetate, isopropanol, and the like, used alone or as blends thereof.

Potentially useful pressure sensitive adhesives suitable for bringing into contact with liner-type webs described herein typically have pressure-sensitive adhesive properties as described in The Handbook of Pressure Sensitive Adhesives, page 172, paragraph 1 (1989). The pressure-sensitive adhesive could be a single pressure-sensitive adhesive or the pressure sensitive adhesive could be a mixture of several pressure-sensitive adhesives. Classes of pressure sensitive adhesives useful in the present invention include, for example, rubber resin materials such as tackified natural rubbers or those based on synthetic rubbers, styrene block copolymers, polyvinyl ethers, acrylic resins such as poly(meth)acrylates (including both acrylates and methacrylates), polyurethanes, poly-a-olefins, silicone resins, and the like. Combinations of these adhesives can be used. Additionally, further useful adhesives include those that may be activated at elevated temperature for application at use temperature. These generally meet the Dahlquist criterion at use temperature.

The pressure sensitive adhesive may be inherently tacky. If desirable, tackifiers may be added to a pressure sensitive adhesive base material to form the pressure sensitive adhesive. Useful tackifiers include, for example, rosin ester resins, aromatic hydrocarbon resins, aliphatic hydrocarbon resins, mixed aromatic/aliphatic hydrocarbon resins, and terpene resins. Other materials can be added for special purposes, including, for example, oils, plasticizers, antioxidants, ultraviolet (“UV”) stabilizers, hydrogenated butyl rubber, pigments, fillers, curing agents, and crosslinkers. Some examples of fillers or pigments include zinc oxide, titanium dioxide, silica, carbon black, metal powders and calcium carbonate.

Acrylic pressure-sensitive adhesives having a wide range of compositions are useful. Typically, the components of the compositions are selected such that the compositions have a glass transition temperature of less than about −20 C. The compositions typically comprise about 70 to 100 weight percent of alkyl ester components, for example, alkyl acrylate components having alkyl groups from 1 to 14 carbons, and about 30 to 10, or 2, or in some cases 0 weight percent of polar interacting components, for example, ethylenically-unsaturated carboxylic acids or ethylenically unsaturated amides. In some embodiments, preferably the compositions may comprise about 70 to 98 weight percent of alkyl ester components and about 30 to 2 weight percent of polar interacting components, and most preferably about 85 to 98 weight percent alkyl ester components and about 15 to 2 weight percent of polar interacting components. The alkyl ester components include, for example, isooctyl acrylate, 2-ethyl-hexyl acrylate, methyl acrylate, ethyl acrylate, n-butyl acrylate, 2-methylbutyl acrylate, isobornylacrylate, and the like. The compositions may include other types of ester components such as, for example, vinyl acetate, methyl methacrylate, and the like. The polar interacting components include, for example, acrylic acid, methacrylic acid, N-vinyl pyrrolidone, N-vinyl caprolactam, methacrylamide, acrylamide, N-alkyl acrylamides, 2-hydroxyethyl acrylate, and the like. The compositions may include other components such as, for example, styrene macromer, and the like.

The acrylic pressure sensitive adhesives may be self-tacky or tackified. Non-limiting examples of potentially useful tackifiers for acrylics are rosin esters such those available under the following trade names: FORAL™ 85, available from Hercules, Inc.; aromatic resins such as PICCOTEX™ LC-55WK; aliphatic resins such as PICCOTAC™ 95, available from Hercules, Inc.; terpene resins such as a-pinene and p-pinene, available as PICCOLYTE™ A-115, ZONAREZ™ B-100 from Arizona Chemical Co., and terpene-phenol resins such as SYLVARES TP 2019 from Arizona Chemical Co.

The performance (tack, peel adhesion, shear adhesion, adhesion to specific substrates) of pressure sensitive adhesives can be tailored to a given application by using crosslinking agents, plasticizers, or other modifiers.

The thickness of the adhesive layer 60 may be dependent upon several factors, including for example, the adhesive composition, the type of structures used to form the microstructured surface, the type of substrate, and the thickness of the confirmable film layer. Those skilled in the art are capable of adjusting the thickness to address specific application factors. In some embodiments, the thickness of the adhesive layer is within a range from about 10 to about 50 microns.

Discontinuous patterned protective layer 70 is in one embodiment a discontinuous hard coat layer. By discontinuous, it is meant that the patterned protective layer 70 does not continuously extend across the full upper surface 50A of conformable film layer 50; rather there are at least some areas of upper surface 50A (such as area 72) that are not covered by the discontinuous patterned protective layer 70. In the embodiment shown in FIG. 2, the discontinuous patterned protective layer 70 is shown as four discrete features 80. As is shown further in FIG. 5, in various embodiments discontinuous patterned protective layer 70 may comprise discrete features, also called islands, such as round shaped islands 80A (FIG. 5A), square shaped islands 80B (FIG. 5B), or random or polygon-shaped islands 80C (FIG. 5C). The edges of the features may be straight or rounded or wavy. The features may be separated by a fixed pitch or pitches. Depending on implementation details, such a regular pitch may make the patterned protective layer visible to someone looking at the film. In some cases, seeing such a pattern may desirable. For example, a texture with visible features may be desirable for mimicking a reptile skin texture or an orange peel type texture. When it is desirable to see the hardcoat features, it has been found that features having a diameter of 100 microns for a rounded feature having a surface area of 7050 micron² or greater may be a suitable choice, up to 0.785 mm² are useful.

The hardcoat features also may be arranged in a pattern which is not noticeable to the eye, for example, random or pseudo-random pitch variations or feature size alterations. When the features are smaller than 100 microns in diameter for round features (area less than 7850 square microns for non-round), more preferably less than 80 microns in diameter (area less than 5024 square microns), even more preferably 60 microns in diameter for a round feature (area less than 2826 square microns) or less the features in some embodiments are unlikely to be seen. It is expected for other shapes that this trend will also hold.

While the examples shown in FIG. 5 show discrete islands of features, other interconnected features are also possible, as where islands are connected to other islands via some pattern of protective coating. The term features as used herein refers broadly to areas of the top surface 50A of conformable film layer 50 in which protective coating is present (e.g., features 80 as shown in the various embodiments of FIG. 5).

Letting the total surface area of the conformable film layer 50 be equal a total area of T, and a first area “A” to equal the total area of the features (e.g., features 80) within T, and a second area “B” to equal the total area of the upper surface 50A that is devoid of features associated with protective patterned layer 70 (e.g., areas 72), then T=A+B. In some embodiments, it has been found that the percentage area of features (A) to non-features (B), to facilitate effective removal, can range from about 5% to nearly 100% area coverage. More desirably, at least 10% of the surface, and less than 85% of the surface, and even more desirably between 15% and 75%, and even more desirably between 25% and 65% of the surface of the film may comprise the patterned layer 70. In such ranges, the printed hardcoat features provide protection of the film from abrasion, chemical staining, and chemical attack, while providing the enhanced removability describe herein, and also may alter the film's appearance in some embodiments (i.e., may provide a matte-type finish to the film). Protection against chemical attack may be an important feature in certain embodiments of car wrap films, since it is likely that these films will be exposed to a variety of chemicals including gasoline, car wash soaps, detergents and waxes, bug and tar removers, etc. Sizes of features that comprise the discontinuous protective pattern may be any suitable size.

Another example of a useful discontinuous hardcoat film comprises a film which is printed with a first patterned hardcoat layer then overprinted with a second hardcoat layer. The overprint in one embodiment would not need to be registered to the first print. Further, the feature size of the second print can be at the lower useful limit of printed hardcoat (60 microns in diameter for a round feature) up to 1 mm in diameter. Further layers of hardcoat can be overprinted as well. This allows for much higher areal coverage of the film—from 60 to 95% or greater, in some embodiments, of the area while still maintaining the removability of the film. Such printing and overprinting may occur within in printing steps that are temporally distinguished from one another (though they may be part of the same web handling operation, for example, some printers have the ability to print multiple layers as part of one web handling operation). In other words, a first printing step disposes the first set of hardcoat features, then a second printing step disposes a second set of hardcoat features, with at least some of the second set of hardcoat features overlapping, or partially overlapping, the first set of hardcoat features. Where the second set of hardcoat features does not overlap the first set, it would interface directly with the underlying substrate's surface. If further printing steps (i.e., third, fourth, etc.) are used, such steps would result in further hardcoat features overlapping or partially overlapping underlying hardcoat features, as well as the underlying substrate, though with each successive overprinting of hardcoat features, the amount of overlapping of the underlying substrate is successively reduced. Embodiments having overprinted features may appear less regular in pattern, and greater variability in the feature islands, which may improve undesirable visual characteristics sometimes associated with a well structured array of features (e.g., moiré). As mentioned, such overprinting allows for higher percentage areal coverage of hardcoat upon the underlying substrate, but enhanced removability characteristics are still preserved.

In the overprinted embodiment just described, a conformable film-based product is the result of printing a first set hardcoat features upon a substrate, then overprinting a second set of hardcoat features, at least some of the second set of hardcoat features partially overlapping the first set, to achieve a total areal coverage of features upon the underlying substrate of between 10% and 75%, 85%, 95%, and even up to 100%.

The discontinuous, patterned protective layer 70 may be made from any suitably curable polymeric material. An example of a suitable material is a multi-functional or cross-linkable monomer. Illustrative cross-linkable monomers include multi-functional acrylates, urethanes, urethane acrylates, siloxanes, and epoxies. In some embodiments, cross-linkable monomers include mixtures of multifunctional acrylates, urethane acrylates, or epoxies. In some embodiments, the hardcoat layer includes a plurality of inorganic nanoparticles. The inorganic nanoparticles can include, for example, silica, alumina, or Zirconia nanoparticles. In some embodiments, the nanoparticles have a mean diameter in a range from 1 to 200 microns, or 5 to 150 microns, or 5 to 125 microns. In illustrative embodiments, the nanoparticles can be “surface modified” such that the nanoparticles provide a stable dispersion in which the nanoparticles do not agglomerate after standing for a period of time, such as 24 hours, under ambient conditions.

The thickness of the discontinuous, patterned protective layer 70 can be any useful thickness. In some embodiments, the features of the protective layer 70 have an average thickness of 1 to 25 microns. In another embodiment, the features have an average thickness of 1 to 15 microns. In another embodiment, the features have an average thickness of 1 to 10 microns.

Useful acrylates include, for example, poly(meth)acryl monomers such as, for example, (a) di(meth)acryl containing compounds such as 1,3-butylene glycol diacrylate, 1,4-butanediol diacrylate, 1,6-hexanediol diacrylate, 1,6-hexanediol monoacrylate monomethacrylate, ethylene glycol diacrylate, alkoxylated aliphatic diacrylate, alkoxylated cyclohexane dimethanol diacrylate, alkoxylated hexanediol diacrylate, alkoxylated neopentyl glycol diacrylate, caprolactone modified neopentylglycol hydroxypivalate diacrylate, caprolactone modified neopentylglycol hydroxypivalate diacrylate, cyclohexanedimethanol diacrylate, diethylene glycol diacrylate, dipropylene glycol diacrylate, ethoxylated (10) bisphenol A diacrylate, ethoxylated (3) bisphenol A diacrylate, ethoxylated (30) bisphenol A diacrylate, ethoxylated (4) bisphenol A diacrylate, hydroxypivalaldehyde modified trimethylolpropane diacrylate, neopentyl glycol diacrylate, polyethylene glycol (200) diacrylate, polyethylene glycol (400) diacrylate, polyethylene glycol (600) diacrylate, propoxylated neopentyl glycol diacrylate, tetraethylene glycol diacrylate, tricyclodecanedimethanol diacrylate, triethylene glycol diacrylate, tripropylene glycol diacrylate; (b) tri(meth)acryl containing compounds such as glycerol triacrylate, trimethylolpropane triacrylate, ethoxylated triacrylates (e.g., ethoxylated (3) trimethylolpropane triacrylate, ethoxylated (6) trimethylolpropane triacrylate, ethoxylated (9) trimethylolpropane triacrylate, ethoxylated (20) trimethylolpropane triacrylate), pentaerythritol triacrylate, propoxylated triacrylates (e.g., propoxylated (3) glyceryl triacrylate, propoxylated (5.5) glyceryl triacrylate, propoxylated (3) trimethylolpropane triacrylate, propoxylated (6) trimethylolpropane triacrylate), trimethylolpropane triacrylate, tris(2-hydroxyethyl)isocyanurate triacrylate; (c) higher functionality (meth)acryl containing compounds such as ditrimethylolpropane tetraacrylate, dipentaerythritol pentaacrylate, ethoxylated (4) pentaerythritol tetraacrylate, pentaerythritol tetraacrylate, caprolactone modified dipentaerythritol hexaacrylate; (d) oligomeric (meth)acryl compounds such as, for example, urethane acrylates, polyester acrylates, epoxy acrylates; polyacrylamide analogues of the foregoing such as, for example, N,N-dimethyl acrylamide; and combinations thereof. Such compounds are widely available from vendors such as, for example, Sartomer Company, Exton, Pa.; UCB Chemicals Corporation, Smyrna, Ga.; and Aldrich Chemical Company, Milwaukee, Wis. Additional useful (meth)acrylate materials include hydantoin moiety-containing poly(meth)acrylates, for example, as described in U.S. Pat. No. 4,262,072 (Wendling et al.).

In an illustrative embodiment, the patterned protective layer 70 includes a monomer having at least two or three (meth)acrylate functional groups. Commercially available cross-linkable acrylate monomers include those available from Sartomer Company, Exton, Pa. such as trimethylolpropane triacrylate available under the trade designation “SR351”, pentaerythritol triacrylate available under the trade designation “SR444”, dipentaerythritol triacrylate available under the trade designation “SR399LV”, ethoxylated (3) trimethylolpropane triacrylate available under the trade designation “SR454”, ethoxylated (4) pentaerythritol triacrylate, available under the trade designation “SR494”, tris(2-hydroxyethyl)isocyanurate triacrylate, available under the trade designation “SR368”, and dipropylene glycol diacrylate, available under the trade designation “SR508”.

Useful urethane acrylate monomers include, for example, a hexafunctional urethane acrylate available under the tradename Ebecryl 8301 from Radcure UCB Chemicals, Smyrna, Ga., CN981 and CN981B88 available from Sartomer Company, Exton, Pa., and a difunctional urethane acrylate available under the tradename Ebecryl 8402 from Radcure UCB Chemicals, Smyrna, Ga. In some embodiments the hardcoat layer resin includes both poly(meth)acrylate and polyurethane material, which can be termed a “urethane acrylate.”

In some embodiments, the nanoparticles are inorganic nanoparticles such as, for example, silica, alumina, or zirconia. Nanoparticles can be present in an amount from 10 to 200 parts per 100 parts of hardcoat layer monomer. Silicas for use in the materials of the invention are commercially available from Nalco Chemical Co. (Naperville, Ill.) under the product designation NALCO COLLOIDAL SILICAS. For example, silicas include NALCO products 1040, 1042, 1050, 1060, 2327 and 2329. Zirconia nanoparticles are commercially available from Nalco Chemical Co. (Naperville, Ill.) under the product designation NALCO OOSSOO8.

Surface treating or surface modification of the nano-sized particles can provide a stable dispersion in the hardcoat layer resin. The surface-treatment can stabilize the nanoparticles so that the particles will be well dispersed in the polymerizable resin and result in a substantially homogeneous composition. Furthermore, the nanoparticles can be modified over at least a portion of its surface with a surface treatment agent so that the stabilized particle can copolymerize or react with the polymerizable hardcoat layer resin during curing.

The nanoparticles can be treated with a surface treatment agent. In general a surface treatment agent has a first end that will attach to the particle surface (covalently, ionically or through strong physisorption) and a second end that imparts compatibility of the particle with the hardcoat layer resin and/or reacts with hardcoat layer resin during curing. Examples of surface treatment agents include alcohols, amines, carboxylic acids, sulfonic acids, phospohonic acids, silanes and titanates. The preferred type of treatment agent is determined, in part, by the chemical nature of the inorganic particle or metal oxide particle surface. Silanes are generally preferred for silica and zirconia (the term “zirconia” includes zirconia metal oxide.) The surface modification can be done either subsequent to mixing with the monomers or after mixing.

In some embodiment, it is preferred to react silanes with the particle or nanoparticle surface before incorporation into the resin. The required amount of surface modifier is dependent upon several factors such as particle size, particle type, modifier molecular wt, and modifier type. In general it is preferred that approximately a monolayer of modifier is attached to the surface of the particle. The attachment procedure or reaction conditions required also depend on the surface modifier used. For silanes it is preferred to surface treat at elevated temperatures under acidic or basic conditions for approximately 1-24 hours approximately. Surface treatment agents such as carboxylic acids do not require elevated temperatures or extended time.

Surface modification of zirconia (ZrO.sub.2) with silanes can be accomplished under acidic conditions or basic conditions. In one embodiment, silanes are preferably heated under acid conditions for a suitable period of time. At which time the dispersion is combined with aqueous ammonia (or other base). This method allows removal of the acid counter ion from the ZrO.sub.2 surface as well as reaction with the silane. Then the particles are precipitated from the dispersion and separated from the liquid phase.

The surface modified particles can be incorporated into the curable resin by various methods. In one embodiment, a solvent exchange procedure is utilized whereby the resin is added to the surface modified nanoparticles, followed by removal of the water and co-solvent (if used) via evaporation, thus leaving the particles dispersed in the polymerizable resin. The evaporation step can be accomplished for example, via distillation, rotary evaporation or oven drying, as desired.

Representative embodiments of surface treatment agents suitable for inclusion in the hardcoat layer include compounds such as, for example, phenyltrimethoxysilane, phenyltriethoxysilane, 2-(3,4-epoxycyclohexyl)ethyltriethoxysilane, 2-(3,4-epoxycyclohexyl)ethyltrimethoxysilane, isooctyl trimethoxy-silane, N-(3-triethoxysilylpropyl) methoxyethoxyethoxyethyl carbamate (PEG3TES), Silquest A1230, N-(3-triethoxysilylpropyl) methoxyethoxyethoxyethyl carbamate (PEG2TES), 3-(methacryloyloxy)propyltrimethoxysilane, 3-acryloxypropyltrimethoxysilane, 3-(methacryloyloxy)propyltriethoxysilane, 3-(methacryloyloxy) propylmethyldimethoxysilane, 3-(acryloyloxypropyl)methyldimethoxysilane, 3-(methacryloyloxy)propyldimethylethoxysilane, 3-(methacryloyloxy) propyldimethylethoxysilane, vinyldimethylethoxysilane, phenyltrimethoxysilane, n-octyltrimethoxysilane, dodecyltrimethoxysilane, octadecyltrimethoxysilane, propyltrimethoxysilane, hexyltrimethoxysilane, vinylmethyldiacetoxysilane, vinylmethyldiethoxysilane, vinyltriacetoxysilane, vinyltriethoxysilane, vinyltriisopropoxysilane, vinyltrimethoxysilane, vinyltriphenoxysilane, vinyltri-t-butoxysilane, vinyltris-isobutoxysilane, vinyltriisopropenoxysilane, vinyltris(2-methoxyethoxy)silane, styrylethyltrimethoxysilane, mercaptopropyltrimethoxysilane, 3-glycidoxypropyltrimethoxysilane, acrylic acid, methacrylic acid, oleic acid, stearic acid, dodecanoic acid, 2-[2-(2-methoxyethoxy)ethoxy]acetic acid (MEEAA), beta-carboxyethylacrylate, 2-(2-methoxyethoxy)acetic acid, methoxyphenyl acetic acid, and mixtures thereof.

A photoinitiator can be included in the hardcoat layer. Examples of initiators include, organic peroxides, azo compounds, quinines, nitro compounds, acyl halides, hydrazones, mercapto compounds, pyrylium compounds, imidazoles, chlorotriazines, benzoin, benzoin alkyl ethers, di-ketones, phenones, and the like. Commercially available photoinitiators include, but not limited to, those available commercially from Ciba Geigy under the trade designations DARACUR 1173, DAROCUR 4265, IRGACURE 651, IRGACURE 184, IRGACURE 1800, IRGACURE 369, IRGACURE 1700, and IRGACURE 907, IRGACURE 819 and from Aceto Corp., Lake Success N.Y., under the trade designations UVI-6976 and UVI-6992. Phenyl-[p-(2-hydroxytetradecyloxy)phenyl]iodonium hexafluoroantomonate is a photoinitiator commercially available from Gelest, Tullytown, Pa. Phosphine oxide derivatives include LUCIRIN TPO, which is 2,4,6-trimethylbenzoy diphenyl phosphine oxide, available from BASF, Charlotte, N.C. In addition, further useful photoinitiators are described in U.S. Pat. Nos. 4,250,311, 3,708,296, 4,069,055, 4,216,288, 5,084,586, 5,124,417, 5,554,664, and 5,672,637. A photoinitiator can be used at a concentration of about 0.1 to 10 weight percent or about 0.1 to 5 weight percent based on the organic portion of the formulation (phr.)

The patterned protective layer 70 described herein can be a hard coat layer cured in an inert atmosphere. It has been found that curing the patterned protective layer 120 in an inert atmosphere can assist in providing/maintaining the scratch and stain resistance properties of the patterned protective layer 70. In some embodiments, the patterned protective layer 70 is cured with a UV light source under a nitrogen blanket.

To enhance durability of the patterned protective layer, especially in outdoor environments exposed to sunlight, a variety of commercially available stabilizing chemicals can be added. These stabilizers can be grouped into the following categories: heat stabilizers, UV light stabilizers, and free-radical scavengers. Heat stabilizers are commercially available from Witco Corp., Greenwich, Conn. under the trade designation “Mark V 1923” and Ferro Corp., Polymer Additives Div., Walton Hills, Ohio under the trade designations “Synpron 1163”, “Ferro 1237” and “Ferro 1720”. Such heat stabilizers can be present in amounts ranging from 0.02 to 0.15 weight percent. UV light stabilizers can be present in amounts ranging from 0.1 to 5 weight percent. Benzophenone type UV-absorbers are commercially available from BASF Corp., Parsippany, N.J. under the trade designation “Uvinol 400”; Cytec Industries, West Patterson, N.J. under the trade designation “Cyasorb UV1164” and Ciba Specialty Chemicals, Tarrytown, N.Y., under the trade designations “Tinuvin 900”, “Tinuvin 123” and “Tinuvin 1130”. Free-radical scavengers can be present in an amount from 0.05 to 0.25 weight percent. Nonlimiting examples of free-radical scavengers include hindered amine light stabilizer (HALS) compounds, hydroxylamines, sterically hindered phenols, and the like. HALS compounds are commercially available from Ciba Specialty Chemicals under the trade designation “Tinuvin 292” and Cytec Industries under the trade designation “Cyasorb UV3581”

The discontinuous, patterned protective layer can be applied to the top surface of the conformable film with commonly known methods such as screen, flexographic, ink jet, or gravure printing. Various coating techniques may also be used, as will be appreciated by one skilled in the art.

Turning now to FIG. 3, the conformable removable film-based article 10, as described above, is shown again, except additionally including substrate 200, and wherein adhesive layer 60 interfaces the conformable film layer 50 to the top surface of substrate 200. Substrate 200 may be any substrate suitable for having a graphic adhered to it. For example, a vehicle surface, such as an automotive wrap, or a boat wrap, etc.

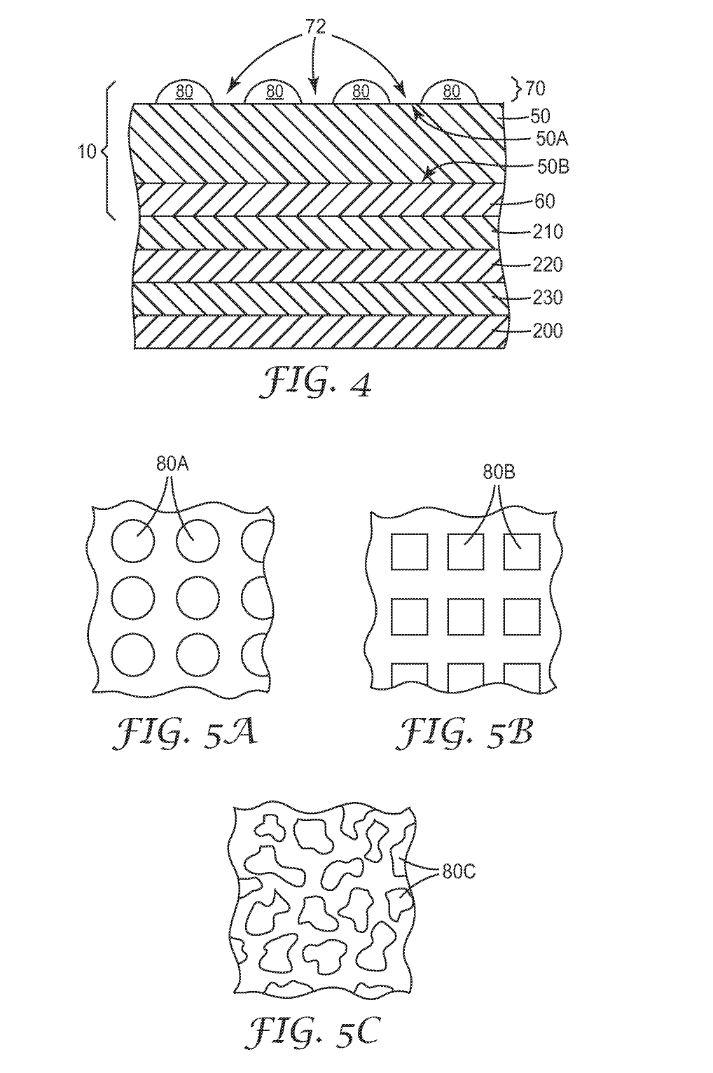

Turning now to FIG. 4, a further embodiment of conformable removable film-based article 10 is shown. In FIG. 4, conformable removable film-based article 10 is optically transparent, and is configured as a protective overlaminate layer relative to a printed film layer. Image layer 210 may be printed, e.g., by inkjet or otherwise, onto film layer 220 (which may be a multi-layer composite film). An adhesive layer 230 then bonds the stack to substrate 200. In this configuration, the discontinuous, patterned protective layer 70 still provides improved removability of the entire film stack from substrate 200.

Turning now to FIG. 5, plan-view drawings are shown of the features that comprise the patterned protective layers in several embodiments. The features may have a variety of shapes—round, square, random.

The features may also be opaque, transparent, translucent, or contain particles to provide added optical effects.

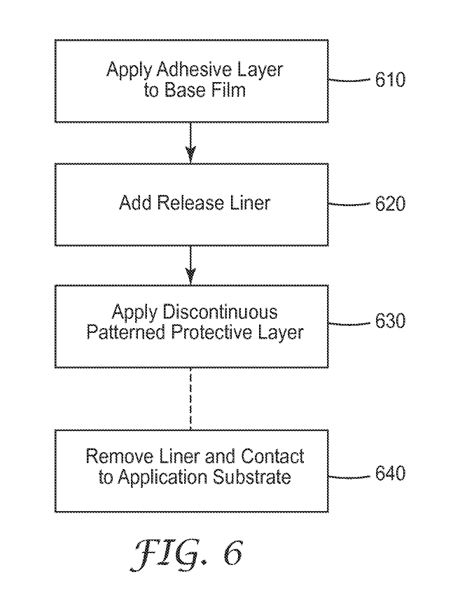

Turning now to FIG. 6, a flowchart is shown representing the steps associated with making a conformable, removable film-based article as described above. An adhesive layer is first applied to the first major surface of a conformable film having a first major surface and a second major surface (610). Typically, this would be in a roll-to-roll process, and the film would be coated. Next, a release liner may be placed on the exposed surface of the adhesive layer (620). At this point, the film, adhesive, and release liner stack may be rolled up and stored as needed. Next, the discontinuous patterned protective layer is applied to the second surface of the conformable film (630). This protective layer may be, for example, ink-jet printed, or gravure, flexographic, rotary screen, or similar as know in the art. Once the protective layer has cured, the film stack may be rolled up and stored. At the time of application, an applicator (person) would remove the liner and bring the exposed adhesive layer in contact with an application substrate, such as a vehicle surface. This may involve repeatedly heating and stretching the film onto the vehicle's surface until it is acceptably positioned, usually with the use of squeegees or the like.

### Examples

Conformable, removable film based articles were prepared using direct contact (flexographic) printing methods. The resultant constructions provide conformable, removable film based articles which provide good removability as measured by peel extension to break testing while providing surface protection of the film via a hardcoat as shown in the following examples.

These examples are merely for illustrative purposes only and are not meant to be limiting on the scope of the appended claims. All parts, percentages, ratios, etc. in the examples and the rest of the specification are by weight, unless noted otherwise. Solvents and other reagents used were obtained from Sigma-Aldrich Chemical Company, St. Louis, Mo. unless otherwise noted. The following abbreviations are used herein: BCM=billion cubic microns; m/min=meters per minute; mm=millimeters; cm=centimeters; um=micrometers.

### Materials:

| Abbreviation | Description |
|---|---|
| F1 | Graphic film, commercially available from 3M Company, |
| | St. Paul, MN as “CONTROLTAC 180-10”. |
| F2 | Overlaminate film, commercially available from 3M |
| | Company, St. Paul, MN as “ENVISION” Gloss Wrap |
| | Overlaminate Film 8548G. |
| AM1 | Acrylate Monomer, Aliphatic Urethane Hexaacrylate, |
| | commercially available from Allnex, Smyrna, GA as |
| | “EBECRYL 8301-R”. |
| AM2 | Acrylate Monomer, Hexanediol Diacrylate, commercially |
| | available from Ciba/BASF, Hawthorne, NY as |
| | “LAROMER” HDDA. |
| AM3 | Acrylate Monomer, Pentaerythritol Tetracrylate, |
| | commercially available from Sigma-Aldrich, St. Louis, |
| | MO as “PETA 408263”. |
| PI1 | Photoinitiator, 70:30 blend of oligo [2-hydroxy-2-methyl- |
| | 1-[4-(1-methylvinyl) phenyl] propanone] and 2- |
| | Hydroxy-2-methyl-1-phenyl-1-propanone, commercially |
| | available from Esstech, Inc., Essington, PA as “PL100” |

### Test Methods

### Sand Abrasion Test

Hardcoat protective films were subjected to an oscillating sand test (ASTM F 735 using a rotary oscillatory shaker made by VWR) where the test conditions were 50 grams of sand, 400 rpm for 60 minutes. It is typically easy to detect scratching of the hardcoat by visually inspecting the samples after testing. In order to quantify the abrasion resistance, the percent of haze in the coated film can be measured and compared before and after testing. Haze was measured with a haze-gard plus manufactured by BYK Gardner, Columbia, Md.

### 180° Peel

ASTM D3330-04 (test method A) was used for the 180 degree peel extension to break testing. Samples (C1-C2 and E1-E4) were laminated to Film F1 using a squeeze roll laminator. 2.5 cm by 20 cm strips were cut from these constructions. The strips were laminated to an aluminum substrate panel from the Q-Lab Corporation (AL-39). Samples were conditioned (72 degrees F. and 50% RH) for 24 hours prior to testing. Samples were tested on Instron Model #5564 from the Instron Corporation, 100 Royall Street, Canton Mass. 02021-1089. Three samples were tested; the reported peel extension to break value is an average of the peel extension to break values from each of the three samples. Data was measured in inches.

### Printed Examples

### Acrylate Formulation:

The printed material is an acrylate formulation composed of 50 wt % AM1, 25 wt % AM2, and 25 wt % AM3 with 1 wt % PI1. This acrylate formulation was thoroughly admixed until all components were in solution to form an essentially “solventless” liquid material.

### Printing Patterns:

Three flexographic printing plates were obtained of the type available from DuPont (Wilmington, Del.) under the trade designation Cyrel DPR. All three plates were processed (by Southern Graphic Systems (SGS, Minneapolis, Minn.)) to comprise predetermined print pattern based on images supplied to Southern Graphic Systems.

Pattern 1—Grid of square features 40 microns on edge with 50 micron gaps.
Pattern 2—Grid of square features 400 microns on edge with 50 micron gaps.
Pattern 3—Random polygon features 430 microns on edge with 100 micron gaps.

Each printing plate comprised an overall size of approximately 30.5×30.5 cm. All three printing plates were manually wiped with isopropanol before printing.

### Example Preparation

A flexographic printing plate with a pattern as shown in Table 1 was mounted on a smooth roll of a flexographic printing apparatus using 1060 Cushion-Mount flexographic plate mounting tape available from 3M. The acrylate formulation described above, was introduced into the flexographic printing apparatus using conventional methods and equipment and was transferred onto the printing surfaces of the flexographic printing plate via the anilox rolls shown in Table 1. The printable composition was then transferred from the anilox roll to a printable film F2 moving at a line speed of approximately 3 meters per minute. The coated film then passed through a UV curing apparatus (available from XericWeb, Neenah, Wis.) that was in-line with the printing apparatus so that the liquid material was satisfactorily cured to form a solid film. Note that Example E4 was double printed. A first printing pass was made and cured and then a second printing was applied over the first and cured (see Table 1).

Control Example C1 had no printing. Control Example C2 was continuously coated with Acrylate Formulation using a #8 Mayer Rod. After coating the sample was cured in a LIGHTHAMMER 6 UV curing system with a D bulb (Heraeus Noblelight Fusion UV Inc., Gaitherburg, Md.). Curing took place at 100% power and 25 ft/min (7.6 m/min).

Sand Abrasion and 180° Peel testing was performed for all the Examples using the Sand Abrasion and 180° Peel Methods above. The peel extension to break and % haze data are shown in Table 1 below.

TABLE 1
Example Printing and Test Results

| | | | Resulting | Peel | |
|---|---|---|---|---|---|
| | Printing | Anilox | coating | Extension to | |
| Example | Pattern | Roll | coverage* | Break (inch) | % Haze |
| C1 | None | None | None | >1.25 | 20.5 |
| C2 | None- | None | 100% | 0.07 (sample | 4 |
| | Continuously | | | broke) | |
| | coated | | | | |
| E1 | P1 | 300 BCM | 20% | >1.25 | 15.6 |
| | | 900 Lines/ | | | |
| | | Inch | | | |
| E2 | P2 | 300 BCM | 80% | >1.25 | 12.6 |
| | | 900 Lines/ | | | |
| | | Inch | | | |
| E3 | P3 - pass 1 | 6.5 BCM | 100% | >1.25 | 10 |
| | | 450 Lines/ | | | |
| | | Inch/ | | | |
| | P2 - pass 2 | 300 BCM | | | |
| | | 900 Lines/ | | | |
| | | Inch | | | |

Anilox rolls available from Interflex, Spartanburg, SC.
*Visually derived.

1. A conformable, removable film-based article, comprising:
a conformable film having a first major surface and a second major surface;
a pressure sensitive adhesive layer on the first major surface of the conformable film; and
a discontinuous, patterned protective layer on at least a portion of the second major surface of the conformable film.

2. The conformable, removable film-based article of claim 1, wherein the patterned protective layer comprises a pattern that has an average areal coverage that is between 10% and 85% of the surface area of the portion of the conformable film.

3. (canceled)

4. The conformable, removable film-based article of claim 1, wherein the discontinuous, patterned protective layer comprises a plurality of features.

5. (canceled)

6. The conformable, removable film-based article of claim 1, wherein the discontinuous, patterned protective layer comprises hard coat features.

7-13. (canceled)

14. The conformable, removable film-based article of claim 6, wherein the hard coat features comprise a first set of hard coat features applied by a first printing process, and a second set of hard coat features that at least partially overlap at least some of the first set of hard coat features, and wherein the second set of hard coat features is applied by a second printing process, and wherein the first printing process and the second printing process are temporally distinct.

15. The conformable, removable film-based article of claim 14, wherein the first printing process and the second printing process are part of the same web handling operation.

16. The conformable, removable film-based article of claim 6, wherein hard coat features are applied by printing methods.

17. The conformable, removable film-based article of claim 7, wherein the hard coat features comprise cross-linked multifunctional acrylates.

18. The conformable, removable film-based article of claim 6, wherein the hard coat features are at least one of: opaque, reflective, or optically transparent.

19. The conformable, removable film-based article of claim 6, wherein the hard coat features are random or pseudo-random.

20-22. (canceled)

23. The conformable, removable film-based article of claim 1, wherein the discontinuous, patterned protective layer is on substantially the entire second major surface of the conformable film.

24. The conformable, removable film-based article of claim 1, wherein the film-based article may be removed from a substrate to which it is adhered without breaking.

25. The conformable, removable film-based article of claim 1, wherein at least 1.5 inches of the film may be removed from a substrate to which it is adhered using a 180 degree peel at least 1.5 inches without breaking.

26. The conformable, removable film-based article of claim 6, wherein the hard coat features comprise any feature selected from the following group of features: squares, circles, polygons.

27. The conformable, removable film-based article of claim 1, wherein the average area coverage is between 25% and 65% of the surface are of the portion of the conformable film.

28. The conformable, removable film-based article of claim 6, wherein the average features size is 1 to 10 microns thick and the average width of one side of the features is at least 10 um to less than 1 mm.

29. The conformable, removable film-based article of claim 1, wherein the article comprises at least one of a vehicle wrapping film or a wall wrapping film.

30-31. (canceled)

32. The conformable, removable film-based article of claim 1, wherein the adhesive layer includes channels that facilitate air egress.

33. The conformable, removable film-based article of claim 1, wherein the film-based article is substantially optically transparent.

34. The conformable, removable film-based article of claim 33, further comprising: additional film-based layers, including at least one printed layer.
